(19) United States
(12) Patent Application Publication
(10) Pub. No.: US 2012/0094262 A1
(43) Pub. Date: Apr. 19, 2012

(54) CHILDREN'S DIGITAL DAY PLANNER

(76) Inventor: Rachel Brodle, Snohomish, WA (US)

(21) Appl. No.: 13/273,454

(22) Filed: Oct. 14, 2011

Related U.S. Application Data
(60) Provisional application No. 61/393,248, filed on Oct. 14, 2010.

(51) Int. Cl. G09B 19/12

(52) U.S. Cl. 434/304

(57) ABSTRACT

A hand-held personal assistance device for a child, and in particular a young child may take the form of a cell phone, a smart phone, a digital tablet or some other hand-held device preferably sized to be comfortably held and manipulated by a small child. The device may be programmed or otherwise configured to provide a visual and/or audible announcement that utilizes alarms, sounds, music or other triggers to get a child's attention at a desired time for a particular task, and thus helps the child develop a learned association with the announcement and the time for the desired task.

### PRIORITY CLAIM

This application claims priority to and the benefit of U.S. Provisional Application No. 61/393,248 entitled CHILDREN'S DIGITAL DAY PLANNER filed Oct. 14, 2010, which is incorporated by reference in its entirety.

### BACKGROUND OF THE INVENTION

Potty training and brushing teeth are just two of the many tasks that are difficult for children to learn and to make habit forming. There are many different potty training techniques that are more playful, but not helpful for the child in gaining the knowledge of a common daily routine. There were fun playful ideas, or reward methods for other tasks as well, but nothing that would help the child develop the habit of learning and doing these tasks on any regular basis. There are many books for learning behavior, but no device that actually helped the child learn these behaviors on a daily basis at this time.

### BRIEF DESCRIPTION OF TITLE DRAWINGS

FIG. 1 is a front, plan view of an alarm-based personal assistance device for a child in accordance with an embodiment of the present invention; and

FIG. 2 is a system diagram of the alarm-based personal assistance device of FIG. 1 in accordance with an embodiment of the present invention.

### DETAILED DESCRIPTION

The present invention is generally directed toward a hand-held personal assistance device for a child, and in particular a young child. The device may take the form of a cell phone, a smart phone, a digital tablet or some other hand-held device preferably sized to be comfortably held and manipulated by a small child. The device may be programmed or otherwise configured to utilize alarms, sounds, music and other triggers to get a child's attention at a particular time for a particular task, and thus helps the child get into a habit of everyday responsibilities.

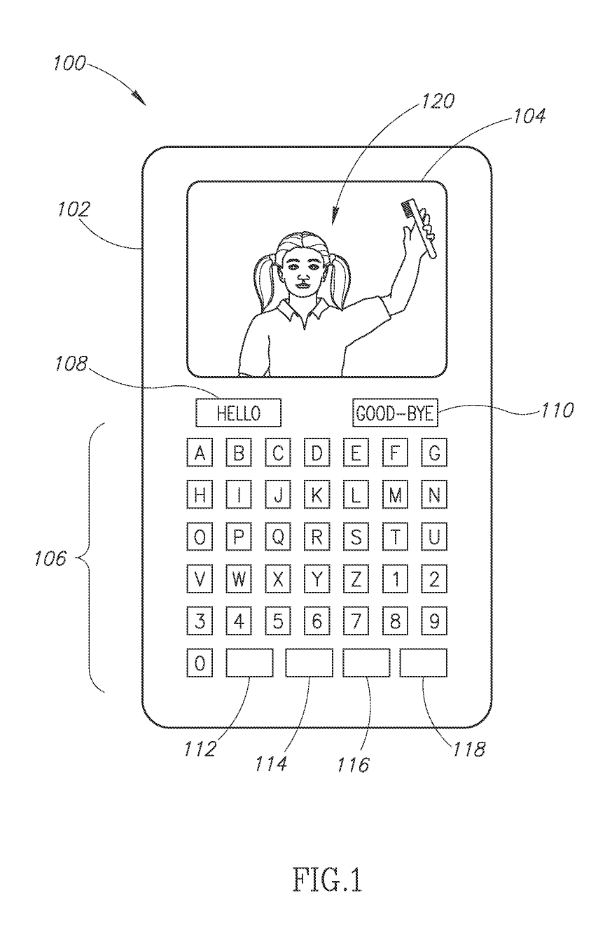

FIG. 1 shows a hand-held personal assistance device 100 for a child (not shown) according to one embodiment. The device 100 includes a housing or case 102 with a display screen 104. The device 100 further includes an input device 106, which preferably takes the form of a button-style keypad having alphanumeric buttons. The input device 106 may take other forms such as a touchscreen keypad or further include a voice recognizer for receiving voice instructions as input commands. In addition, the device 100 includes an ON button 108, an OFF button 110 and a plurality of character buttons 112, 114, 116, and 118. While the illustrated embodiment shows four character buttons, it is appreciated that the device 100 may include fewer or more character buttons. The operation of the display screen 104, the input device 106 and the character buttons 112-118 is described in detail below.

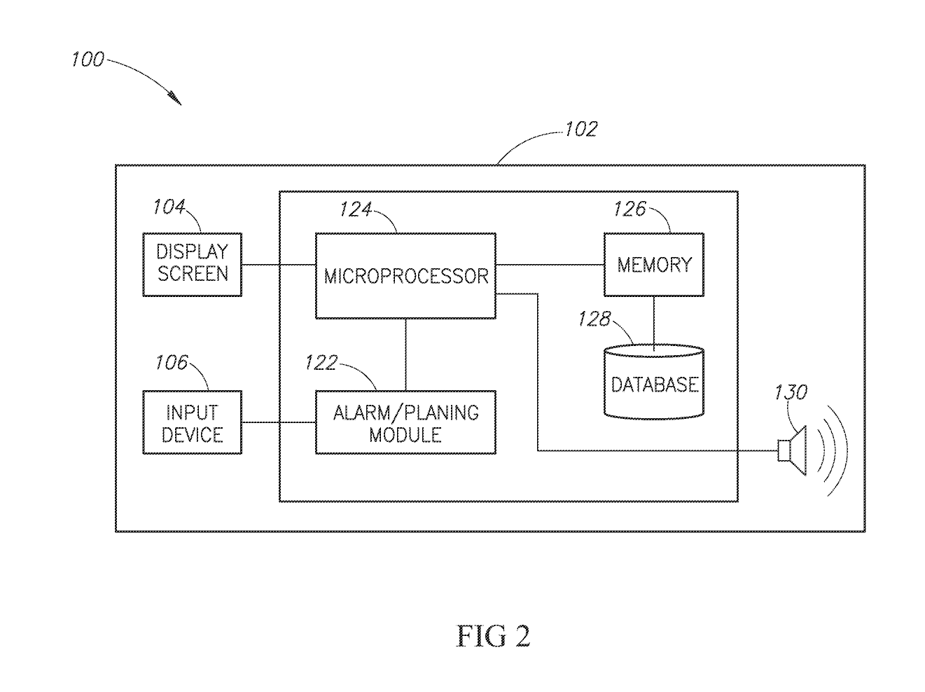

FIG. 2 shows a system diagram for the hand-held personal assistance device 100. In one embodiment, the internal components of the device 100 include an alarm/planning software module 122 in communication with a microprocessor 124. A memory 126, which may obtain information from one or more databases 128, communicates with the microprocessor 124. The device 100 may further include one or more sound output devices 130, which may take the form of a speaker, and which is controlled by the microprocessor 124.

In an example embodiment, the alarm/planning software module 122 may be implemented using standard programming techniques. For example, the alarm/planning software module 122 may provide executable instructions to the microprocessor 124, along with one or more static or dynamic memories 126 that receive inputs from the input device 106, ON/OFF buttons 108, 110, and/or the character buttons 112-118. In general, the alarm/planning software module 122 may be implemented with programming languages known in the art such as, but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

In addition, the alarm/planning software module 122 may receive instructions from other input devices such as a USB port that permits the device 100 to be connected to a computer where a calendar of times and dates may be viewed and manipulated. Some of the programming interfaces for the alarm/planning software module 122 can be made available by standard mechanisms such as through C, C++, C#, and Java APIs; libraries for accessing files, databases, or other data repositories; through languages such as XML; or through Web servers, FTP servers, or other types of servers providing access to data.

Furthermore, in some embodiments, some or all of the components of the device 100 may be implemented or provided in other manners, such as at least partially firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and. the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

Referring back to FIG. 1, one of the purposes of the device 100 allows children to respond to an animated character that calls or otherwise activates the pre-programmed device to let make the child aware of certain times, such as bathroom time, eating time, nap time, or some other time that may be important to the child and/or the child's parent. The parent, nanny or other caretaker may program the device 100 with one or more activity times, assign characters to those activity times, and then operate to provide an audio or visual reminder to the child of the activity time while helping them learn how to responsibly manage their day.

By way of example, the character buttons 112-118 may each correspond to a different character designated for a particular activity. For example, character 112 may appear on the display screen 102 at a pre-programmed time and provide the audio and/or visual reminder for a predetermined amount of time. When the child answers the device then the character 112 may say something like “hey let's go potty,” or “I think ifs time to go to the big kid's potty room”. This will remind the child in a fun way that it is time to go and try to potty again.

Likewise, character 114 may provide a time to eat reminder, character 116 may provide a time to brush teeth reminder, and character 118 may provide a time to read reminder. Thus, the different characters will reinforce different activities for the child while operating as a reminder that the activity is happening, about to happen or should happen.

The device 100 may have one or more functions that the parent may control. By way of example, one function may be a programming mode in which the parent inputs the times and assigns characters. Another function may be a play or operational mode that may be activated by the parent by entering a password or pin number. In the play mode, the device 100 would be locked from receiving additional programming input except for the operation of the ON/OFF buttons 108, 110. In the play mode, the keypad buttons may provide audible number pronunciations, alphabet pronunciations or songs when pressed by the child. The programming mode may be opened by entering the same or a different password or pin number.

The ON/OFF buttons, 108, 110 may trigger the device 100 to announce “hello” or “goodbye,” respectively whether in English or some other language. The character buttons 112-118 may be programmable to trigger a particular character to appear on the display screen 104 and sing a song or talk about an upcoming activity such as brushing teeth, eating or going to bed. Thus over time, the child learns to quickly associate the character to the activity or time. Further, the child may selectively push one of the character buttons to see the character sing a song or provide a reminder.

In one embodiment, the device 100 operates as an alarm phone and digital day planner for children. The alarm set times may be set by a parent or caretaker according to a programming or instructional guide. The device 100 may include a contact list accessible by the caretaker in which selected names may be associated with selected characters, for example the contact name “Dad” may be associated with a cartoon bear.

As previously noted, the character buttons 112-118 may be associated with alarm set times such than when the present time equals the alarm set time then the appropriate character will appear on the display screen 104. The device 100 may be programmed to ring for a few times before automatically answering itself, and then instructing the child to perform a required task.

In one embodiment, the device 100 includes four characters: Ricky raccoon instructs the child to use the restroom; Sam-Sue instructs the child to brush their teeth; Virgil instructs the child that it is time to eat (e.g., lunch, dinner, or snacks); and Timmy Turtleson instructs the child that it is time for bed or for a nap. There may be other characters for other times and/or tasks, such as doing a particular chore around the house.

The device 100 may include some type of clip-on mechanism so the child or caretaker can carry the device in a hands-free manner. The volume of the instructions or song supplied by each character may be adjusted for different situations.

In another embodiment, the device 100 may include a recorder for the parents or child to record their voice or name, or any sort of sound that can be used as a ring tone for the device. The device 100 may come pre-programmed with a set of ring tones, but the option of a recorded sound would also be an option for a ring tone.

From the foregoing it will be appreciated that, although specific embodiments have been described herein for purposes of illustration, various modifications may be made without deviating from the spirit and scope of this disclosure.

1. A device comprising:
a housing;
a microprocessor located within the housing, the microprocessor operable to process machine readable instructions; and
a plurality of buttons selectable to associate a character with a set time for a desired task; and
a display screen arranged in the housing for showing the character at the set time and thereby provide, for a child, a learned association between an appearance of the character on the display screen and the set time for the desired task.

2. The method of claim 1 further comprising a speaker arranged in the housing for audibly alerting the child when the set time for the desired task equals a present time.

3. The method of claim 2 wherein the character associated with the desired task is viewable on the display screen during the audible alerting of the child.

4. The method of claim 1 wherein the plurality of buttons includes alphanumeric buttons and character association buttons.

5. The method of claim 1 wherein the characters are cartoon characters.

6. The method of claim 1 wherein the housing is configured to be grippable by a small child.

7. A device comprising:
a housing with a display screen;
a microprocessor located within the housing, the microprocessor operable to process machine readable instructions;
a plurality of buttons selectable to associate a character with a set time for a desired task; and
a speaker arranged in the housing for audibly alerting a child when the set time for the desired task equals a present time, wherein the character associated with the desired task is contemporaneously viewable on the display screen.

8. The method of claim 7 wherein the machine readable instructions are modifiable with the plurality of buttons.

9. The method of claim 7 wherein the character operates o demonstrate the desired task when viewable on the display screen.

10. The method of claim 7 wherein the plurality of buttons includes alphanumeric buttons and character association buttons.

11. The method of claim 7 wherein the characters are cartoon characters.

12. The method of claim 7 wherein the housing is configured to be grippable by a small child.

13. A method for providing a learned association for a child, the method comprising:
receiving machine readable instructions that associate a displayable character with a set time for a task;
determining a present time; and
providing an announcement to a child that the set time for the task equals the present time.

14. The method of claim 13 wherein providing the announcement includes showing the displayable character on a display screen.

15. The method of claim 13 wherein receiving machine readable instructions includes interpreting information from at least one or more buttons being depressed on a children's learning device.

16. The method of claim 13 wherein providing the announcement includes providing an audible message through a speaker.
